(19) United States
(12) Patent Application Publication
(10) Pub. No.: US 2025/0391087 A1
(43) Pub. Date: Dec. 25, 2025

(54) METHOD FOR GENERATING MODEL, TERMINAL AND STORAGE MEDIUM

(71) Applicant: Beijing Zitiao Network Technology Co., Ltd., Beijing (CN)

(72) Inventors: Panwang PAN, Beijing (CN); Zeming LI, Beijing (CN)

(21) Appl. No.: 19/244,440

(22) Filed: Jun. 20, 2025

(30) Foreign Application Priority Data
Jun. 20, 2024 (CN) 202410798724.9

(51) Int. Cl. G06T 15/00; G06T 7/50; G06T 7/70; G06T 7/80; G06V 10/42; G06V 10/80

(52) U.S. Cl. CPC G06T 15/00; G06T 7/50; G06T 7/70; G06T 7/80; G06V 10/42; G06V 10/806

(57) ABSTRACT

A method for generating a model, a terminal and a storage medium are provided. The method includes: acquiring a single first picture in which a target object is displayed; acquiring an object pose-shape parameter of the target object in the first picture; converting sampling points of the target object in the first picture from a target space to a preset canonical space according to the object pose-shape parameter; determining a global feature corresponding to the sampling points in the canonical space and a pixel-level feature corresponding to the sampling points in the canonical space; and obtaining a model parameter of the target object according to the global feature of the sampling points in the canonical space and the pixel-level feature of the sampling points in the canonical space.

### CROSS-REFERENCE TO RELATED APPLICATION

The present application claims priority of the Chinese Patent Application No. 202410798724.9, filed on Jun. 20, 2024, the disclosure of which is incorporated herein by reference in its entirety as part of the present application.

### TECHNICAL FIELD

The present disclosure relates to the field of computer technology, in particular to a method and an apparatus for generating a model, a terminal and a storage medium.

### BACKGROUND

Model reconstruction based on a picture model reconstruction refers to a process in which objects such as human bodies are extracted from a picture and restored into a 3D digital model, and then the model is controlled to generate a new picture. Model reconstruction based on a single view has a wide range of applications in such fields as virtual reality and augmented reality.

### SUMMARY

The present disclosure provides a method and an apparatus for generating a model, a terminal and a storage medium.

The present disclosure uses the following technical scheme.

In some embodiments, the present disclosure provides a method for generating a model, and the method includes:
acquiring a single first picture in which a target object is displayed, where the first picture is a 3D picture;
acquiring an object pose-shape parameter of the target object in the first picture;
converting sampling points of the target object in the first picture from a target space to a preset canonical space according to the object pose-shape parameter, where the target space is a space in the first picture, the canonical space is a space having a preset object template, the object template is an object having a preset standard pose-shape parameter, and the sampling points are multiple;
determining a global feature corresponding to the sampling points in the canonical space and a pixel-level feature corresponding to the sampling points in the canonical space; and
obtaining a model parameter of the target object according to the global feature of the sampling points in the canonical space and the pixel-level feature of the sampling points in the canonical space.

In some embodiments, the present disclosure provides an apparatus for generating a model, and the apparatus includes an acquiring unit and a processing unit.

The acquiring unit is configured to acquire a single first picture in which a target object is displayed, where the first picture is a 3D picture.

The processing unit is configured to acquire an object pose-shape parameter of the target object in the first picture.

The processing unit is further configured to convert sampling points of the target object in the first picture from a target space to a preset canonical space according to the object pose-shape parameter, where the target space is a space in the first picture, the canonical space is a space having a preset object template, the object template is an object having a preset standard pose-shape parameter, and the sampling points are multiple.

The processing unit is further configured to determine a global feature corresponding to the sampling points in the canonical space and a pixel-level feature corresponding to the sampling points in the canonical space.

The processing unit is further configured to obtain a model parameter of the target object according to the global feature of the sampling points in the canonical space and the pixel-level feature of the sampling points in the canonical space.

In some embodiments, the present disclosure provides a terminal, which includes at least one memory and at least one processor.

The at least one memory is configured to store program codes, and the at least one processor is configured to invoke the program codes stored in the at least one memory to perform any one of the methods described above.

In some embodiments, the present disclosure provides a computer-readable storage medium. The computer-readable storage medium is configured to store program codes, and when the program codes are run by a computer, the computer is caused to perform any one of the methods described above.

The method provided in the embodiments of the present disclosure implements an effect of model reconstruction from a single first picture of an arbitrary viewing angle and pose, reduces the requirements for input data, and has a good generalization ability.

### BRIEF DESCRIPTION OF DRAWINGS

In conjunction with the accompanying drawings and with reference to the following specific embodiments, the above and other features, advantages and aspects of each embodiment of the present disclosure will become more apparent. Throughout the accompanying drawing, identical or similar drawing marks indicate the same or similar elements. It should be understood that drawings are schematic and that elements and elements are not necessarily drawn to scale.

FIG. 1 is a flowchart of a method for generating a model of an embodiment of the present disclosure.

FIG. 2 is schematic diagram of an object template of an embodiment of the present disclosure.

FIG. 3 is a schematic diagram of a method for generating a model of an embodiment of the present disclosure.

FIG. 4 is a schematic diagram of a method for generating a model of an embodiment of the present disclosure.

FIG. 5 is a schematic structural diagram of an electronic device of an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that the modification of “one” mentioned in the present disclosure is schematic rather than restrictive, and those skilled in the art should understand that unless otherwise explicitly stated in the context, it should be understood as “one or more”.

The names of messages or information exchanged between a plurality of apparatuses in the embodiments of disclosure are for illustrative purposes only and are not intended to limit the scope of such messages or information.

The scheme provided in the embodiments of the present disclosure will be described in detail in combination with the drawings.

The technology of generating a 3D digital human body model of human bodies from pictures may be applied to such technical fields as virtual reality and augmented reality. For example, the technology may be used for virtual fitting to simulate an effect of people of various body shapes after wearing clothes. For another example, the technology may be used for games and animation, so as to create personalized game characters and animation figures. In related technologies, the technologies are mainly divided into two types. In the first type of technology, the reconstruction time is long and the quality is poor. In this type of technology, a monocular human body picture is adopted to reconstruct and drive the 3D digital human body model, such as PIFU (Pixel-Aligned Implicit Function for High-Resolution Clothed Human Digitization, pixel-aligned implicit function method) and SiFU (Side-view Conditioned Implicit Function for Real-world Usable Clothed Human Reconstruction, side-view conditioned implicit function). The type of methods mainly focuses on fine modeling and dynamic driving of specific digital human bodies, but usually faces problems of long optimization time and insufficient performance in generalization to a wide range of digital human body reconstruction tasks. The second type of technology has a good reconstruction effect, but requires a plurality of input pictures. In this type of technology, in order to improve the reconstruction efficiency of the 3D digital human body, human body pictures of multiple viewing angles are adopted as input to reconstruct human neural radiation fields, such as ActorsNeRF (Animatable Few-shot Human Rendering with Generalizable NeRFs, using generalizable NeRF for animated few-lens human body rendering). This type of technology usually relies on multi-view human body pictures of a specific camera viewing angle as input, and the application of this type of technology is limited.

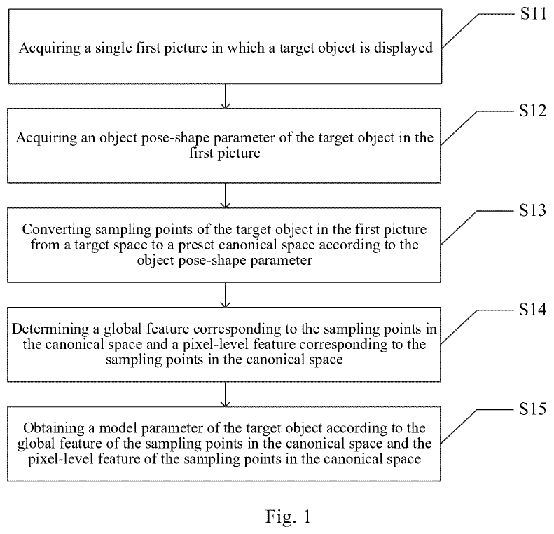

As shown in FIG. 1, FIG. 1 is a flowchart of a method for generating a model of an embodiment of the present disclosure, and the method includes the following steps.

S11: acquiring a single first picture in which a target object is displayed.

In some embodiments, an executor of the method provided in the present disclosure may be a terminal or a server. The target object is a specific object, the object may be a person, and the target object is a specific person. The first picture is a single picture, and the first picture is a 3D picture (also known as a stereoscopic picture). In this step, a single picture is used as input, and only one picture needs to be acquired, with no need of acquiring a plurality of pictures of different viewing angles, which reduces requirements for input data.

S12: acquiring an object pose-shape parameter of the target object in the first picture.

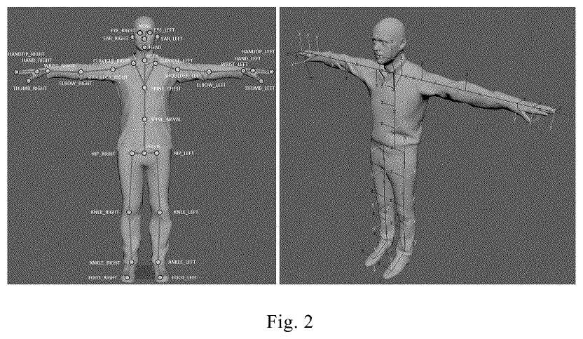

In some embodiments, the first picture is analyzed. Specifically, an SMPL (Skinned Multi-Person Linear) model, an SMPL-X model, or a PyMAF (3D Human Pose and Shape Regression with Pyramidal Mesh Alignment Feedback Loop) model may be used to analyze the first picture, the object pose-shape parameter of the target object displayed in the first picture is extracted. The object pose-shape parameter describes the shape and pose of the target object in the first picture. In some embodiments, an object template having a standard pose-shape parameter is preset, and the object pose-shape parameter of the target object is characterized by the difference between the target object in the first picture and the object template. For example, the target object is a person, and the object target is a preset human body template having standard pose-shape parameters (as shown in FIG. 2). By comparing the difference between the target object and the human body template, the difference is used as the object pose-shape parameter of the target object.

S13: converting sampling points of the target object in the first picture from a target space to a preset canonical space according to the object pose-shape parameter.

In some embodiments, the target space is a space in the first picture, the canonical space is a space having a preset object template, the object template is an object having a preset standard pose-shape parameter, and the sampling points are multiple. In the target space (i.e., in the space of the first picture), the target object has an arbitrary pose. In the present embodiment, an object template having a standard pose-shape parameter is preset. Since the object pose-shape parameter of the target object and the preset standard pose-shape parameter are known, i.e., the pose-shape of the target object and the pose-shape of the object template are known, sampling points on the target object may be converted from the target object to the object target in the canonical space through translation and rotation, i.e., the positions of the sampling points on the target object in the canonical space are known, i.e., the sampling points on the object target corresponding to the sampling points of the target object. Different objects have varying heights, widths, depths in poses, therefore, the positions of the sampling points are also different. By setting a canonical space, the positions of the sampling points are unified, and the positions of the sampling points in the canonical space are the same. For example, 6890 vertices and 23 joint points are set as sampling points in the SMPL, the sampling points in the object template are fixed, and the sampling points of the target object extracted from the first picture are converted to the canonical space, so as to determine which sampling points in the canonical space correspond to the sampling points in the first picture. Through such a standardization process, subsequent processing such as feature fusion can be performed.

S14: determining a global feature corresponding to the sampling points in the canonical space and a pixel-level feature corresponding to the sampling points in the canonical space.

S15: obtaining a model parameter of the target object according to the global feature of the sampling points in the canonical space and the pixel-level feature of the sampling points in the canonical space.

In some embodiments, the sampling points in the canonical space are points that are converted from the sampling points in the target space in S13 to the canonical space. The global feature represents overall information and approximate distribution of the target object. The pixel-level feature carries more detailed spatial and local information, such as an edge and a texture. Since not all the regions of the target object may be displayed in the first picture, invisible regions need to be predicted. Therefore, the global feature is used to integrate characteristics of the overall general features, so that the invisible regions may be predicted. The pixel-level feature is a finer feature. When the invisible regions are predicted, the problem of insufficient precision when the global feature is used for prediction may be supplemented. The combination of the global feature and the pixel-level feature may realize the effects of predicting invisible regions and performing fine reconstruction on the invisible regions.

After the global feature and the pixel-level feature are obtained, the model parameter of the target object may be predicted. Specifically, a 3D Gaussian parameter of the target object may be predicted. The 3D Gaussian parameter includes, for example, a center position of the Gaussian distribution, a covariance matrix, color and opacity. Specifically, taking the target object being a person as an example, the center position of each Gaussian distribution is predicted by using the extracted feature, especially the feature related to the location of the parts. This essentially aims at locating approximate coordinates of various parts of the human body in a 3D space. The step of predicting the covariance matrix of each Gaussian distribution through analyzing a relative relationship between the movement trend in the feature and parts of the human body, helps to determine the shape, orientation and uncertainty range of the movement of the body parts, and enhances the ability of the model in expressing dynamic and morphological changes. Based on the appearance or texture information included in the feature, the color of the body region represented by each Gaussian distribution is predicted, which helps to reconstruct the realistic color on the surface of the human body model. The opacity parameter of each part is inferred according to the feature, and affect the visibility and depth perception of the human body structure in the final rendered picture, which makes some parts look more “solid” while other parts may appear more transparent due to occlusion or distance.

After the model parameter of the target object is obtained, a 3D model of the target object may be created according to the model parameter. Specifically, taking the model parameter including a 3D Gaussian parameter as an example, after the 3D Gaussian parameter is obtained, Gaussian Splatting may be performed, that is, the 3D Gaussian distributions are superimposed together to reconstruct a continuous body surface. Each Gaussian distribution represents a small region on the surface of the human body, and by superimposing these distributions, a 3D human body model with rich details and realism may be generated. The existing 3D Gaussian Splatting requires a plurality of pictures of different viewing angles. In the present embodiment, only a single first picture is required to generate a 3D Gaussian model, and may be used to generate a picture of a new viewing angle.

In some embodiments of the present disclosure, a method for generating a model is provided. In the method, the object template is used as the prior knowledge, the sampling points in the target space are converted to the canonical space, and the global feature and the pixel feature are fused. The method implements an effect of accurate 3D model reconstruction from a single first picture of an arbitrary viewing angle and pose, reduces the requirements for input data, and has a good generalization ability.

In some embodiments of the present disclosure, the step of acquiring an object pose-shape parameter of the target object in the first picture includes: acquiring a shape parameter of the target object in the first picture and a pose parameter of the target object in the first picture. The shape parameter is used to describe a figure shape of the target object, and the pose parameter is used to describe an action pose of the target object.

In some embodiments, an SMPL model is used to acquire a shape parameter and a pose parameter. Taking the target object being a human body as an example, the SMPL model defines N=6890 vertices and K=23 joint points, and these points may be used as sampling points. The sampling points selected by the SMPL model are few, which is conducive to improving the calculation speed. The human body is described by the shape parameter β and the pose parameter θ as follows. The shape parameter β uses 10 feature vector dimensions to describe the figure shape of the input picture, and each dimension may be interpreted as an indicator of human body shape, such as weight or height. The pose parameter θ uses 24×3 feature vector dimensions to describe the action pose of the human body, one dimension 24 refers to 1 root node and 23 joint points, and the second dimension 3 refers to the axis angle value. In some embodiments, the shape difference and the pose difference of the target object relative to the object template may be used as the shape parameter and the pose parameter of the target object, which is beneficial to reducing the amount of data and is convenient to convert the sampling points from the target space to the canonical space.

In some embodiments of the present disclosure, the step of converting sampling points of the target object in the first picture from a target space to a preset canonical space according to the object pose-shape parameter includes: irradiating a ray in the target space according to the object pose-shape parameter of the target object in the target space and an extrinsic camera parameter of the first picture, selecting the sampling points on the ray, and using inverse linear blending skinning transformation to convert the sampling points of the target space to the canonical space.

In some embodiments, the first picture is a picture that is shot according to its extrinsic camera parameter (for example, including a camera position and a camera viewing angle). The irradiated virtual ray according to the camera position and the camera viewing angle simulates a sight line path from a camera to a target object surface when pictures are actually taken. In each irradiated ray path, a series of sampling points will be sampled in the target space. These sampling points represent the surface position of the possible target object. Through the set of these sampling points, a three-dimensional shape of the target object may be gradually constructed. LBS (Linear Blending Skinning) transformation is an algorithm in the SMPL model and is used to calculate positions of vertices after blending skinning, then through such an algorithm, the positions in the canonical space may be converted to other spaces (such as the target space). For example, the target object has m joint points and n vertices, then the following formula is used to calculate the position of the vertex in the target space from the position in the canonical space:

$${p}^{′} = {\sum }_{j = 1}^{m} {w}_{j} ( p ) {T}_{j} p ,$$

where p′ is the position of the vertex after blending skinning in the target space with a dimension of [n, 3], and w is a weight matrix with a dimension of [n, m]; and T is the affine transformation matrix of each joint point with a dimension of [m, 4, 4], and the affine transformation matrix represents rotation and translation of the joint point. T is related to the body shape of the target object and will also be affected by the pose. The shape parameter (height, weight, etc.) of the target object affects the range of movement, and the pose parameter affects the range of actual rotation, because the joint cannot be twisted by 180 degrees actually. p is the position of the vertex in the canonical space before blending skinning. Through ILBS (Inverse Linear Blending Skinning) transformation, the points in the target space are converted to the points in the canonical space.

In some embodiments of the present disclosure, the step of determining a global feature corresponding to the sampling points in the canonical space includes: extracting a one-dimensional feature of each position from the first picture; converting the one-dimensional feature to a tri-plane feature on three planes of the canonical space; determining projection points of the sampling points in the canonical space on the three planes; and determining the tri-plane feature corresponding to the projection points on the three planes as the global feature corresponding to the sampling points in the canonical space.

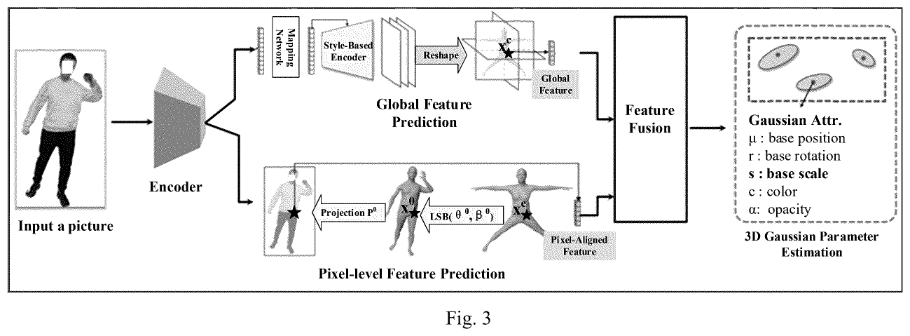

In some embodiments, the input picture is the first picture as shown in the section “Global Feature Prediction” in FIG. 3. The one-dimensional feature may be extracted from the first picture by using a two-dimensional encoding network (2D Encoder), and the one-dimensional feature may be further converted to a tri-plane feature in the canonical space by using a mapping network and a style-based encoding network (Style-Based Encoder). The three planes may include a plane where an x axis and a y axis are located in the canonical space, a plane where the y axis and a z axis are located, and a plane where the z axis and the x axis are located, i.e., the tri-plane refers to three planes, and the one-dimensional feature is converted on the three planes. Each plane has a converted feature, the features on the three planes are the tri-plane feature, and then the sampling points in the canonical space are respectively projected onto the three planes to obtain three projection points, the set of features of the three projection points on their respective planes is the tri-plane feature corresponding to the projection points on the three planes, and the tri-plane feature is taken as the global feature corresponding to the sampling points.

In some embodiments of the present disclosure, the step of determining a pixel-level feature corresponding to the sampling points in the canonical space includes: extracting a two-dimensional feature of each position from the first picture; converting the sampling points from the canonical space to the target space to obtain a conversion position; and determining the two-dimensional feature corresponding to the conversion position as the pixel-level feature corresponding to the sampling points in the canonical space.

In some embodiments, as in the section “Pixel-level Feature Prediction” in FIG. 3, for an input picture (the first picture), a two-dimensional feature is extracted by using a two-dimensional encoding network (2D Encoder, i.e., the encoder in FIG. 3), and the two-dimensional feature may also be represented by an imaging plane (the first picture on a right side of the encoder pointed by the arrow where Projection P⁰ is located in FIG. 3 is an imaging plane that represents the two-dimensional feature). The linear blending skinning (LBS) transformation of the SMPL algorithm is used to convert the sampling points in the canonical space to the sampling points in the target space. This process requires the use of the object pose-shape parameter. As shown in FIG. 3, the human body of a “big” shape in the section “Pixel-level Feature Prediction” in FIG. 3 is an object template, and the position x^{c} of a sampling point thereon is converted to the target space through the LBS algorithm to obtain a conversion position x⁰. The conversion position is the position of a sampling point in the target space after the sampling point is converted from the canonical space to the target space. The conversion position is projected onto the imaging plane that represents the two-dimensional feature, and at the projected position, a two-dimensional feature is extracted as the pixel-level feature.

In some embodiments of the present disclosure, the step of obtaining a model parameter of the target object according to the global feature of the sampling points in the canonical space and the pixel-level feature of the sampling points in the canonical space includes: using a transformer model to perform feature fusion on the global feature and the pixel-level feature to obtain a fused feature; and using the fused feature, the global feature and the pixel-level feature to predict a 3D Gaussian parameter of the target object. The model parameter of the target object includes the 3D Gaussian parameter.

In some embodiments, a multi-input transformer may be constructed. Each input feature is represented by a global feature Q_{g} and a pixel-level feature Kₚ and Vₚ, respectively, i.e., the transformer has two independent input paths corresponding to the global feature and the pixel-level feature, respectively. Such a design allows the transformer to comprehend and fuse features from different scales, and its attention calculation is expressed as:

$$Attention ( {Q}_{g} , {K}_{p} , {V}_{p} ) = softmax ( ( \frac{{Q}_{g} {K}_{p}^{T}}{\sqrt{{d}_{k}}} ) {V}_{p} ) .$$

The attention of the global feature and the pixel-level feature is computed to cause the transformer to dynamically identify and emphasize those parts of information that are most critical to the current task, whether the information is the overall global context or local details. These attentions will play a role in the multi-head attention (MHA) of the transformer. The multi-head attention and feed-forward network are further used to fuse the features, Transformer(X)=LayerNorm(FFN(MHA(X)+X). MHA(X) represents the multi-head attention function applied to the spliced feature X, and X is the multi-head attention input generated according to the attention. MHA is a core component of the transformer and allows for a flexible allocation of attention between different parts of the input. In the present embodiment, MHA is applied to the input after splicing together the global feature and the pixel-level feature, implying that not only interdependence of individual features is considered, but also the relationship between the global feature and the pixel-level feature is considered, thereby enhancing the interaction between features. The FFN is a feed-forward neural network used to further convert the output of self-attention and finally stabilize the training by residual connection and LayerNorm (layer normalization). The method allows the model to process and fuse features from different data sources in the same framework, thereby improving the accuracy of final prediction and the generalization ability of the model. The 3D Gaussian parameter of the target object is predicted through the fused feature, the global feature and the pixel-level feature. Specifically, as shown in FIG. 3, the center position (base position) of the Gaussian distribution, the covariance matrix (used to characterize the rotation angle (base rotation)), color and opacity are predicted. These 3D Gaussian parameter may be used to generate a 3D Gaussian model of the target object.

In some embodiments of the present disclosure, after obtaining a 3D Gaussian parameter or generating a 3D Gaussian model of the target object, the method further includes: according to the model parameter of the target object and an input parameter, generating a generated picture of the target object that conforms to the input parameter. The input parameter includes an input object pose-shape parameter and/or an input extrinsic camera parameter.

In some embodiments, one or more of the object pose-shape parameter and the extrinsic camera parameter may be input. In response to no object pose-shape parameter being input, the object pose-shape parameter of the target object in the first picture may be used, at this time, the generated picture of the target object will have the same shape and pose as the target object in the first picture. In response to the input object pose-shape parameter being different from the pose-shape parameter of the target object in the first picture, then the target object in the generated picture may have a different shape or pose from the target object in the first picture. The input object pose-shape parameter may include only an input pose parameter, at this time, only the pose of the target object is adjusted, so that the target object in the generated picture has the pose indicated by the input pose parameter, the target object in the generated picture conforms to the input object pose-shape parameter, and the pose of the target object in the generated picture is different from the pose of the target object in the first picture. An extrinsic camera parameter may be or may not be input. When the extrinsic camera parameter is not input, the extrinsic camera parameter of the first picture may be used, and the extrinsic camera parameter usually include a camera position and a camera viewing angle, at this time, the camera position and the camera viewing angle of the generated picture are the same as the camera position and the camera viewing angle of the first picture. The input extrinsic camera parameter may be different from the extrinsic camera parameter of the first picture, for example, the camera viewing angles are different, at this time, the generated picture conforms to the camera viewing angle in the input extrinsic camera parameter, and the camera viewing angle of the generated picture is different from the camera viewing angle of the first picture. Therefore, the generated picture of any object pose-shape parameter and camera external parameter in the target space may be generated according to the present embodiment.

In some embodiments of the present disclosure, after generating a generated picture of the target object that conforms to the input parameter, the method further includes: using the generated picture and a second picture of the target object to construct a loss function, and converging and optimizing a 3D Gaussian parameter of the target object by the loss function. The second picture is a real picture of the target object, the object pose-shape parameter of the target object in the second picture is same as the object pose-shape parameter of the target object in the generated picture, and the second picture and the generated picture have a same camera viewing angle.

In some embodiments, after obtaining the generated picture, the 3D Gaussian parameter may be further optimized. The loss function is calculated by using a second picture of the target object that is actually shot and the generated picture, and the second picture is in one-to-one correspondence with the generated picture. The second picture and the corresponding generated picture have the same extrinsic camera parameter and the same object pose-shape parameter. The loss function may be as follows:

$$ℒ ( y , \hat{y} ) = {\sum }_{i = 1}^{n} \vert {y}_{i} - {\hat{y}}_{i} \vert + {\sum }_{i = 1}^{n} \vert {m}_{i} - {\hat{m}}_{i} \vert .$$

[symbol] (y, ŷ) is a loss function, yᵢ is a second picture of the ith camera viewing angle, and i represents the camera viewing angle. There are n camera viewing angles, n second pictures and n generated pictures in total. m represents a mask corresponding to the second picture, and mᵢ represents a generated picture of the ith camera viewing angle. When the target object is a human body, the mask is a human body mask. The difference between the generated picture and the second picture is calculated through the loss function, and the 3D Gaussian parameter is continuously iterated to make the loss function as small as possible.

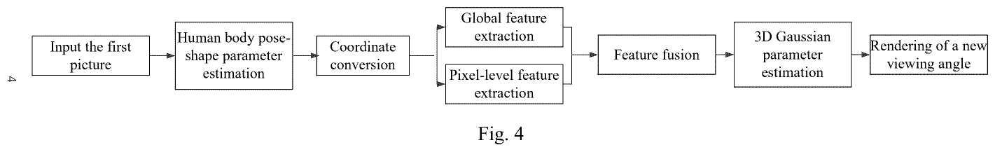

In FIG. 4, the method flow in some embodiments of the present disclosure is shown as a whole by taking the target object as a human body as an example. A first picture is input, and the first picture is a human body picture. The human body pose-shape parameter is estimated. For the input first picture, an SMPL algorithm is used to estimate the corresponding pose parameter and shape parameter.

Coordinate conversion: using the LBS to convert the sampling points from the target space to the canonical space.

Feature extraction: using the 2D coding network to extract 1D features, converting the 1D features into a tri-plane feature, and projecting to extract a global feature; extracting 2D features, and extracting a pixel-level feature through linear blending skinning (LBS) transformation and projection to a picture plane.

Feature fusion: using a transformer model to fuse the global feature and the pixel feature.

Rendering of a picture with a new viewing angle: inputting a camera position, a camera viewing angle and a fused feature into the 3D Gaussian model to acquire information such as density and color, and generating a final multi-view human body picture through rendering.

In some embodiments of the present disclosure, object templates are taken as prior knowledge, the sampling points are effectively converted from the target space to the canonical space, thereby allowing accurate 3D reconstruction from a single picture with arbitrary viewing angles and poses. Features at different levels (global, pixel-level) are fused by using the transformer model to implement effective information exchange and fusion between features, thereby enhancing the quality and realism of the final 3D model. By using 3D Gaussian to generate the color value of the corresponding pixel in space and by making full use of its advantages, higher rendering quality and faster rendering speed may be implemented.

Embodiments of the present disclosure have excellent generalization ability and are able to accurately represent and reconstruct a variety of human body models with different body shapes and poses. Whether the human body is tall, thin and robust or of other particular body shapes, or of a variety of complex poses, the body shapes may be effectively captured and accurately simulated. The technology has favorable application values in a variety of fields such as personalized digital human creation and virtual fitting owing to its wide adaptability.

When a parameter-based representation method is adopted, complex human body geometric information and pose changes may be exhaustively expressed by a small number of control parameters (e.g., the vertex and joint point parameters of the SMPL model). The technical advantage of this parameterization lies in small size of data, thereby facilitating storage and transfer and simultaneously simplifying the process of model operation and modification, and greatly facilitating frequent adjustment of human model attributes (e.g., character design in animation production and game development).

In the present disclosure, a high-quality 3D human body model is reconstructed from a single picture, thereby reducing the cost and technical threshold of traditional 3D modeling and animation production. Secondly, the reconstruction process is fast and efficient (>150 FPS), thereby being applicable to real-time application scenarios.

The present disclosure further provides an apparatus for generating a model, and the apparatus includes an acquiring unit and a processing unit.

The acquiring unit is configured to acquire a single first picture in which a target object is displayed, where the first picture is a 3D picture.

The processing unit is configured to acquire an object pose-shape parameter of the target object in the first picture.

The processing unit is further configured to convert sampling points of the target object in the first picture from a target space to a preset canonical space according to the object pose-shape parameter, where the target space is a space in the first picture, the canonical space is a space having a preset object template, the object template is an object having a preset standard pose-shape parameter, and the sampling points are multiple.

The processing unit is further configured to determine a global feature corresponding to the sampling points in the canonical space and a pixel-level feature corresponding to the sampling points in the canonical space.

The processing unit is further configured to obtain a model parameter of the target object according to the global feature of the sampling points in the canonical space and the pixel-level feature of the sampling points in the canonical space.

In some embodiments, the acquiring an object pose-shape parameter of the target object in the first picture, includes: acquiring a shape parameter of the target object in the first picture and a pose parameter of the target object in the first picture.

The shape parameter is used to describe a figure shape of the target object, and the pose parameter is used to describe an action pose of the target object.

In some embodiments, the converting sampling points of the target object in the first picture from a target space to a preset canonical space according to the object pose-shape parameter, includes:
irradiating a ray in the target space according to the object pose-shape parameter of the target object in the target space and an extrinsic camera parameter of the first picture, selecting the sampling points on the ray, and using inverse linear blending skinning transformation to convert the sampling points of the target space to the canonical space.

In some embodiments, the determining a global feature corresponding to the sampling points in the canonical space, includes:
extracting a one-dimensional feature of each position from the first picture;
converting the one-dimensional feature to a tri-plane feature on three planes of the canonical space;
determining projection points of the sampling points in the canonical space on the three planes; and
determining the tri-plane feature corresponding to the projection points on the three planes as the global feature corresponding to the sampling points in the canonical space.

In some embodiments, the determining a pixel-level feature corresponding to the sampling points in the canonical space, includes:
extracting a two-dimensional feature of each position from the first picture;
converting the sampling points from the canonical space to the target space to obtain a conversion position; and
determining the two-dimensional feature corresponding to the conversion position as the pixel-level feature corresponding to the sampling points in the canonical space.

In some embodiments, the obtaining a model parameter of the target object according to the global feature of the sampling points in the canonical space and the pixel-level feature of the sampling points in the canonical space, includes: using a transformer model to perform feature fusion on the global feature and the pixel-level feature to obtain a fused feature; and using the fused feature, the global feature and the pixel-level feature to predict a 3D Gaussian parameter of the target object; where the model parameter of the target object includes the 3D Gaussian parameter.

In some embodiments, the processing unit is further configured to generate a generated picture of the target object that conforms to the input parameter according to the model parameter of the target object and an input parameter; where the input parameter includes an input object pose-shape parameter and/or an input extrinsic camera parameter.

In some embodiments, a target object in the generated picture conforms to the input object pose-shape parameter, and a pose of the target object in the generated picture is different from a pose of the target object in the first picture.

In some embodiments, the generated picture conforms to a camera viewing angle in the input extrinsic camera parameter, and a camera viewing angle of the generated picture is different from a camera viewing angle of the first picture.

In some embodiments, after generating a generated picture of the target object that conforms to the input parameter, the processing unit is further configured to use the generated picture and a second picture of the target object to construct a loss function, and converging and optimizing a 3D Gaussian parameter of the target object by the loss function.

The second picture is a real picture of the target object, the object pose-shape parameter of the target object in the second picture is same as the object pose-shape parameter of the target object in the generated picture, and the second picture and the generated picture have a same camera viewing angle.

For the embodiments of the apparatus, because they basically corresponds to the method embodiments, the relevant places can be referred to the part description of the method embodiments. The apparatus embodiments described above are only schematic, and the modules described therein as descriptions of the separation modules may or may not be separated. Some or all of the modules may be selected according to actual needs to implement the purpose of the present embodiments. A person skilled in the art can understand and implement it without creative effort.

The method and apparatus of the present disclosure are illustrated according to the embodiments and the application examples. In addition, the present disclosure provides a terminal and a storage medium, which are described below.

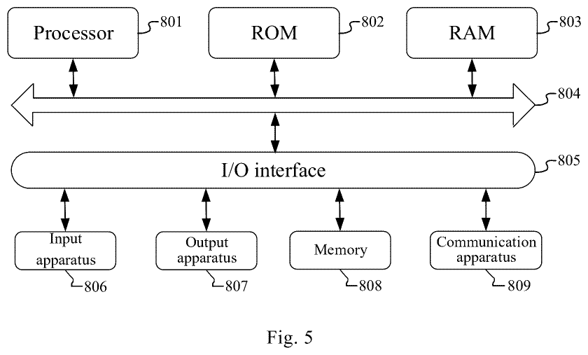

Referring to FIG. 5 below, FIG. 5 illustrates a schematic structural diagram of an electronic device 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 800 may include a processor 801 (e.g., a central processing unit, a graphics processing unit, etc.), which can perform various suitable actions and processing according to a program stored in a read-only memory (ROM) 802 or a program loaded from a memory 808 into a random-access memory (RAM) 803. The RAM 803 further stores various programs and data required for operations of the electronic device 800. The processor 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a memory 808 including, for example, a magnetic tape, a hard disk, or the like; and a communication apparatus 809. The communication apparatus 809 may allow the electronic device 800 to be in wireless or wired communication with other devices to exchange data. While FIG. 5 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the memory 808, or may be installed from the ROM 802. When the computer program is executed by the processor 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a background image; display an initial picture of a target visual effect at a preset position of the background image; control the target visual effect to gradually change from the initial picture to a target picture in response to a visual effect change instruction triggered by a user; and adjust a filter effect of the background image to allow the filter effect of the background image to gradually change from a first filter effect to a second filter effect during a change of the target visual effect.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a method for generating a model is provided, and the method includes:
acquiring a single first picture in which a target object is displayed, where the first picture is a 3D picture;
acquiring an object pose-shape parameter of the target object in the first picture;
converting sampling points of the target object in the first picture from a target space to a preset canonical space according to the object pose-shape parameter, where the target space is a space in the first picture, the canonical space is a space having a preset object template, the object template is an object having a preset standard pose-shape parameter, and the sampling points are multiple;
determining a global feature corresponding to the sampling points in the canonical space and a pixel-level feature corresponding to the sampling points in the canonical space; and
obtaining a model parameter of the target object according to the global feature of the sampling points in the canonical space and the pixel-level feature of the sampling points in the canonical space.

According to one or more embodiments of the present disclosure, a method for generating a model is provided. The acquiring an object pose-shape parameter of the target object in the first picture, includes:
acquiring a shape parameter of the target object in the first picture and a pose parameter of the target object in the first picture.

The shape parameter is used to describe a figure shape of the target object, and the pose parameter is used to describe an action pose of the target object.

According to one or more embodiments of the present disclosure, a method for generating a model is provided, and the converting sampling points of the target object in the first picture from a target space to a preset canonical space according to the object pose-shape parameter, includes:
irradiating a ray in the target space according to the object pose-shape parameter of the target object in the target space and an extrinsic camera parameter of the first picture, selecting the sampling points on the ray, and using inverse linear blending skinning transformation to convert the sampling points of the target space to the canonical space.

According to one or more embodiments of the present disclosure, a method for generating a model is provided, and the determining a global feature corresponding to the sampling points in the canonical space, includes:
extracting a one-dimensional feature of each position from the first picture;
converting the one-dimensional feature to a tri-plane feature on three planes of the canonical space;
determining projection points of the sampling points in the canonical space on the three planes; and
determining the tri-plane feature corresponding to the projection points on the three planes as the global feature corresponding to the sampling points in the canonical space.

According to one or more embodiments of the present disclosure, a method for generating a model is provided, and the determining a pixel-level feature corresponding to the sampling points in the canonical space, includes:
extracting a two-dimensional feature of each position from the first picture;
converting the sampling points from the canonical space to the target space to obtain a conversion position; and
determining the two-dimensional feature corresponding to the conversion position as the pixel-level feature corresponding to the sampling points in the canonical space.

According to one or more embodiments of the present disclosure, a method for generating a model is provided, and the obtaining a model parameter of the target object according to the global feature of the sampling points in the canonical space and the pixel-level feature of the sampling points in the canonical space, includes:
using a transformer model to perform feature fusion on the global feature and the pixel-level feature to obtain a fused feature; and
using the fused feature, the global feature and the pixel-level feature to predict a 3D Gaussian parameter of the target object.

The model parameter of the target object includes the 3D Gaussian parameter.

According to one or more embodiments of the present disclosure, a method for generating a model is provided, and further includes:
according to the model parameter of the target object and an input parameter, generating a generated picture of the target object that conforms to the input parameter.

The input parameter includes an input object pose-shape parameter and/or an input extrinsic camera parameter.

According to one or more embodiments of the present disclosure, a method for generating a model is provided. A target object in the generated picture conforms to the input object pose-shape parameter, and a pose of the target object in the generated picture is different from a pose of the target object in the first picture.

According to one or more embodiments of the present disclosure, a method for generating a model is provided. The generated picture conforms to a camera viewing angle in the input extrinsic camera parameter, and a camera viewing angle of the generated picture is different from a camera viewing angle of the first picture.

According to one or more embodiments of the present disclosure, a method for generating a model is provided, and after the generating a generated picture of the target object that conforms to the input parameter, the method further includes:
using the generated picture and a second picture of the target object to construct a loss function, and converging and optimizing a 3D Gaussian parameter of the target object by the loss function.

The second picture is a real picture of the target object, the object pose-shape parameter of the target object in the second picture is same as the object pose-shape parameter of the target object in the generated picture, and the second picture and the generated picture have a same camera viewing angle.

According to one or more embodiments of the present disclosure, an apparatus for generating a model is provided, and includes an acquiring unit and a processing unit.

The acquiring unit is configured to acquire a single first picture in which a target object is displayed, where the first picture is a 3D picture.

The processing unit is configured to acquire an object pose-shape parameter of the target object in the first picture.

The processing unit is further configured to convert sampling points of the target object in the first picture from a target space to a preset canonical space according to the object pose-shape parameter, where the target space is a space in the first picture, the canonical space is a space having a preset object template, the object template is an object having a preset standard pose-shape parameter, and the sampling points are multiple.

The processing unit is further configured to determine a global feature corresponding to the sampling points in the canonical space and a pixel-level feature corresponding to the sampling points in the canonical space.

The processing unit is further configured to obtain a model parameter of the target object according to the global feature of the sampling points in the canonical space and the pixel-level feature of the sampling points in the canonical space.

According to one or more embodiments of the present disclosure, a terminal is provided and includes at least one memory and at least one processor.

The at least one memory is configured to store program codes, and the at least one processor is configured to invoke the program codes stored in the at least one memory to perform any one of the methods described above.

According to one or more embodiments of the present disclosure, a computer-readable storage medium is provided. The computer-readable storage medium is configured to store program codes, and when the program codes are run by a computer, the computer is caused to perform any one of the methods described above.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A method for generating a model, comprising:
acquiring a single first picture in which a target object is displayed, wherein the first picture is a three-dimensional (3D) picture;
acquiring an object pose-shape parameter of the target object in the first picture;
converting sampling points of the target object in the first picture from a target space to a preset canonical space according to the object pose-shape parameter, wherein the target space is a space in the first picture, the canonical space is a space having a preset object template, the object template is an object having a preset standard pose-shape parameter, and the sampling points are multiple;
determining a global feature corresponding to the sampling points in the canonical space and a pixel-level feature corresponding to the sampling points in the canonical space; and
obtaining a model parameter of the target object according to the global feature of the sampling points in the canonical space and the pixel-level feature of the sampling points in the canonical space.

2. The method according to claim 1, wherein the acquiring an object pose-shape parameter of the target object in the first picture, comprises:
acquiring a shape parameter of the target object in the first picture and a pose parameter of the target object in the first picture; and
wherein the shape parameter is used to describe a figure shape of the target object, and the pose parameter is used to describe an action pose of the target object.

3. The method according to claim 1, wherein the converting sampling points of the target object in the first picture from a target space to a preset canonical space according to the object pose-shape parameter, comprises:
irradiating a ray in the target space according to the object pose-shape parameter of the target object in the target space and an extrinsic camera parameter of the first picture, selecting the sampling points on the ray, and using inverse linear blending skinning transformation to convert the sampling points of the target space to the canonical space.

4. The method according to claim 1, wherein the determining a global feature corresponding to the sampling points in the canonical space, comprises:
extracting a one-dimensional feature of each position from the first picture;
converting the one-dimensional feature to a tri-plane feature on three planes of the canonical space;
determining projection points of the sampling points in the canonical space on the three planes; and
determining the tri-plane feature corresponding to the projection points on the three planes as the global feature corresponding to the sampling points in the canonical space.

5. The method according to claim 1, wherein the determining a pixel-level feature corresponding to the sampling points in the canonical space, comprises:
extracting a two-dimensional feature of each position from the first picture;
converting the sampling points from the canonical space to the target space to obtain a conversion position; and
determining the two-dimensional feature corresponding to the conversion position as the pixel-level feature corresponding to the sampling points in the canonical space.

6. The method according to claim 1, wherein the obtaining a model parameter of the target object according to the global feature of the sampling points in the canonical space and the pixel-level feature of the sampling points in the canonical space, comprises:
using a transformer model to perform feature fusion on the global feature and the pixel-level feature to obtain a fused feature; and
using the fused feature, the global feature and the pixel-level feature to predict a 3D Gaussian parameter of the target object;
wherein the model parameter of the target object comprises the 3D Gaussian parameter.

7. The method according to claim 1, further comprising:
according to the model parameter of the target object and an input parameter, generating a generated picture of the target object that conforms to the input parameter;
wherein the input parameter comprises an input object pose-shape parameter and/or an input extrinsic camera parameter.

8. The method according to claim 7, wherein a target object in the generated picture conforms to the input object pose-shape parameter, and a pose of the target object in the generated picture is different from a pose of the target object in the first picture;
and/or;
the generated picture conforms to a camera viewing angle in the input extrinsic camera parameter, and a camera viewing angle of the generated picture is different from a camera viewing angle of the first picture.

9. The method according to claim 7, wherein after the generating a generated picture of the target object that conforms to the input parameter, the method further comprises:
using the generated picture and a second picture of the target object to construct a loss function, and converging and optimizing a 3D Gaussian parameter of the target object by the loss function; and
wherein the second picture is a real picture of the target object, the object pose-shape parameter of the target object in the second picture is same as the object pose-shape parameter of the target object in the generated picture, and the second picture and the generated picture have a same camera viewing angle.

10. A terminal, comprising:
at least one memory and at least one processor;
wherein the at least one memory is configured to store program codes, and the at least one processor is configured to invoke the program codes stored in the at least one memory to perform a method for generating a model, and the method comprises:
acquiring a single first picture in which a target object is displayed, wherein the first picture is a three-dimensional (3D) picture;
acquiring an object pose-shape parameter of the target object in the first picture;
converting sampling points of the target object in the first picture from a target space to a preset canonical space according to the object pose-shape parameter, wherein the target space is a space in the first picture, the canonical space is a space having a preset object template, the object template is an object having a preset standard pose-shape parameter, and the sampling points are multiple;
determining a global feature corresponding to the sampling points in the canonical space and a pixel-level feature corresponding to the sampling points in the canonical space; and
obtaining a model parameter of the target object according to the global feature of the sampling points in the canonical space and the pixel-level feature of the sampling points in the canonical space.

11. A non-transitory computer-readable storage medium, wherein the non-transitory computer-readable storage medium is configured to store program codes, when the program codes are run by a computer, the computer is caused to perform a method for generating a model, and the method comprises:
acquiring a single first picture in which a target object is displayed, wherein the first picture is a three-dimensional (3D) picture;
acquiring an object pose-shape parameter of the target object in the first picture;
converting sampling points of the target object in the first picture from a target space to a preset canonical space according to the object pose-shape parameter, wherein the target space is a space in the first picture, the canonical space is a space having a preset object template, the object template is an object having a preset standard pose-shape parameter, and the sampling points are multiple;
determining a global feature corresponding to the sampling points in the canonical space and a pixel-level feature corresponding to the sampling points in the canonical space; and
obtaining a model parameter of the target object according to the global feature of the sampling points in the canonical space and the pixel-level feature of the sampling points in the canonical space.

12. The terminal according to claim 10, wherein the acquiring an object pose-shape parameter of the target object in the first picture, comprises:
acquiring a shape parameter of the target object in the first picture and a pose parameter of the target object in the first picture; and
wherein the shape parameter is used to describe a figure shape of the target object, and the pose parameter is used to describe an action pose of the target object.

13. The terminal according to claim 10, wherein the converting sampling points of the target object in the first picture from a target space to a preset canonical space according to the object pose-shape parameter, comprises:
irradiating a ray in the target space according to the object pose-shape parameter of the target object in the target space and an extrinsic camera parameter of the first picture, selecting the sampling points on the ray, and using inverse linear blending skinning transformation to convert the sampling points of the target space to the canonical space.

14. The terminal according to claim 10, wherein the determining a global feature corresponding to the sampling points in the canonical space, comprises:
extracting a one-dimensional feature of each position from the first picture;
converting the one-dimensional feature to a tri-plane feature on three planes of the canonical space;
determining projection points of the sampling points in the canonical space on the three planes; and
determining the tri-plane feature corresponding to the projection points on the three planes as the global feature corresponding to the sampling points in the canonical space.

15. The terminal according to claim 10, wherein the determining a pixel-level feature corresponding to the sampling points in the canonical space, comprises:
extracting a two-dimensional feature of each position from the first picture;
converting the sampling points from the canonical space to the target space to obtain a conversion position; and
determining the two-dimensional feature corresponding to the conversion position as the pixel-level feature corresponding to the sampling points in the canonical space.

16. The terminal according to claim 10, wherein the obtaining a model parameter of the target object according to the global feature of the sampling points in the canonical space and the pixel-level feature of the sampling points in the canonical space, comprises:
using a transformer model to perform feature fusion on the global feature and the pixel-level feature to obtain a fused feature; and
using the fused feature, the global feature and the pixel-level feature to predict a 3D Gaussian parameter of the target object;
wherein the model parameter of the target object comprises the 3D Gaussian parameter.

17. The terminal according to claim 10, further comprising:
according to the model parameter of the target object and an input parameter, generating a generated picture of the target object that conforms to the input parameter;
wherein the input parameter comprises an input object pose-shape parameter and/or an input extrinsic camera parameter.

18. The terminal according to claim 17, wherein a target object in the generated picture conforms to the input object pose-shape parameter, and a pose of the target object in the generated picture is different from a pose of the target object in the first picture;
and/or;
the generated picture conforms to a camera viewing angle in the input extrinsic camera parameter, and a camera viewing angle of the generated picture is different from a camera viewing angle of the first picture.

19. The terminal according to claim 17, wherein after the generating a generated picture of the target object that conforms to the input parameter, the method further comprises:
using the generated picture and a second picture of the target object to construct a loss function, and converging and optimizing a 3D Gaussian parameter of the target object by the loss function; and
wherein the second picture is a real picture of the target object, the object pose-shape parameter of the target object in the second picture is same as the object pose-shape parameter of the target object in the generated picture, and the second picture and the generated picture have a same camera viewing angle.

20. The non-transitory computer-readable storage medium according to claim 11, wherein the acquiring an object pose-shape parameter of the target object in the first picture, comprises:
acquiring a shape parameter of the target object in the first picture and a pose parameter of the target object in the first picture; and
wherein the shape parameter is used to describe a figure shape of the target object, and the pose parameter is used to describe an action pose of the target object.
